(19) United States
(12) Patent Application Publication
(10) Pub. No.: US 2008/0218800 A1
(43) Pub. Date: Sep. 11, 2008

(54) IMAGE PROCESSING APPARATUS, IMAGE PROCESSING METHOD, AND COMPUTER PROGRAM PRODUCT

(75) Inventor: Hiroyuki Baba, Kanagawa (JP)

Correspondence Address: COOPER & DUNHAM, LLP, 1185 AVENUE OF THE AMERICAS, NEW YORK, NY, 10036, US

(73) Assignee: Ricoh Company, Ltd, Tokyo (JP)

(21) Appl. No.: 12/041,877

(22) Filed: Mar. 4, 2008

(30) Foreign Application Priority Data
Mar. 8, 2007 (JP) 2007-059122

(51) Int. Cl. H04N 1/00

(52) U.S. Cl. 358/1.18; 358/488

(57) ABSTRACT

A document detecting unit detects a document from color image data of a plurality of rectangular areas at a specific position on a scanning plate, to determine a document size in a main-scanning direction. An average-value calculating unit calculates an average value of each component of the color image data in a rectangular area. A binarizing unit binarizes the average value calculated by the average-value calculating unit. A determining unit determines a presence of the document based on a result obtained by the binarizing unit.

### CROSS-REFERENCE TO RELATED APPLICATIONS

The present application claims priority to and incorporates by reference the entire contents of Japanese priority document, 2007-059122 filed in Japan on Mar. 8, 2007.

### BACKGROUND OF THE INVENTION

1. Field of the Invention

The present invention relates to an image processing apparatus, an image processing method, an image processing program, and a recording medium used for a digital copying machine, a facsimile machine, an image scanner, and the like.

2. Description of the Related Art

Conventionally, in image processing apparatuses such as a copying machine, the sheet size of a document on a scanning plate automatically detected. For example, in Japanese Patent Application Laid-open No. 2000-321684, an image processing apparatus includes a reader that reads image data of the document line by line, a document size detector that detects a document size in any one of a main-scanning direction and a sub-scanning direction of the document, and a document-size recognizing unit that recognizes the document size in the other direction of the document. Accordingly, the presence of the document can be detected.

In the image processing apparatus in Japanese Patent Application Laid-open No. 2000-321684, monochrome image data is used to determine the document size. However, there are documents with various colors, and if monochrome data is used to detect the document size with respect to a color document, there is a problem that accuracy in document size determination deteriorates. For example, a document in which a detection point is colored with low brightness is determined based on the monochrome image data, it is simply determined that density is high, and if this is binarized, it is mistakenly detected that there is no document.

### SUMMARY OF THE INVENTION

It is an object of the present invention to at least partially solve the problems in the conventional technology.

According to an aspect of the present invention, there is an image processing apparatus including a document detecting unit that detects a document from color image data of a plurality of rectangular areas at a predetermined position on a scanning plate, to determine a document size in a main-scanning direction; an average-value calculating unit that calculates an average value of each component of the color image data in a rectangular area; a binarizing unit that binarizes the average value calculated by the average-value calculating unit; and a determining unit that determines a presence)of the document based on a result obtained by the binarizing unit.

Furthermore, according to another aspect of the present invention, there is provided an image processing method including detecting a document from color image data of a plurality of rectangular areas at a predetermined position on a scanning plate, to determine a document size in a main-scanning direction; calculating an average value of each component of the color image data in a rectangular area; binarizing the average value calculated at the calculating; and determining a presence of the document based on a result obtained at the binarizing.

Moreover, according to still another aspect of the present invention, there is provided a computer program product comprising a computer-usable medium having computer-readable program codes embodied in the medium that when executed cause a computer to execute detecting a document from color image data of a plurality of rectangular areas at a predetermined position on a scanning plate, to determine a document size in a main-scanning direction; calculating an average value of each component of the color image data in a rectangular area; binarizing the average value calculated at the calculating; and determining a presence of the document based on a result obtained at the binarizing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of an image processing apparatus according to one embodiment of the present invention;

FIG. 2 is a block diagram of a control system according to the embodiment;

FIG. 3 is a side view in a platen reading mode;

FIG. 4 is a side view in a document-convey reading mode;

FIG. 5 is a block diagram of a read-signal processing unit;

FIG. 6 is a block diagram of details of the read-signal processing unit;

FIG. 7 is a block diagram of an image data processor;

FIG. 8 is a flowchart of a process performed by a pre-image processing unit;

FIG. 9 is a flowchart of a process performed by a post-image processing unit;

FIG. 10 is a graph of density adjustment;

FIG. 11 depicts a lookup table conversion method for the density adjustment;

FIG. 12 is a flowchart of a process according to the embodiment;

FIG. 13 is a plan view of an actual situation in document detection;

FIG. 14 is a flowchart of entire document detection;

FIG. 15 is, a flowchart in the document detection;

FIG. 16 is a flowchart of a document detection process;

FIG. 17 depicts a configuration of a memory;

FIG. 18 is a flowchart of average calculation in the document detection process; and

FIG. 19 depicts a line in a main-scanning direction.

### DETAILED DESCRIPTION OF THE PREFERRED EMBODIMENTS

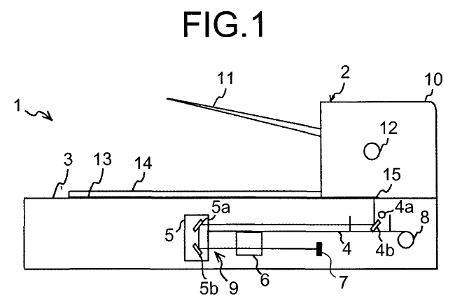

Exemplary embodiments of the present invention will be explained in detail below with reference to the accompanying drawings. FIG. 1 is a schematic diagram of an image reading device of a color multifunction product (MFP) as an embodiment of the present invention.

The image reading device includes a main unit 1, a document conveying unit 2, and a scanning plate 3. A scanning optical system 9 is provided in the main unit 1, which includes a first moving body 4 including a light source 4a formed of a xenon lamp or a fluorescent lamp and a mirror 4b, a second moving body 5 including mirrors 5a and 5b, a lens 6, a one-dimensional photoelectric transducer (three-line charge-coupled device (CCD) for reading a color image) 7 (hereinafter, “CCD 7”), and a stepping motor 8 that drives the first moving body 4 and the second moving body 5.

An SDF unit 10 and a document tray 11 are provided in the document conveying unit 2. A stepping motor 12 for conveying a document is provided in the SDF unit 10. A document cover platen 14 is mounted on the upper part of the scanning plate 3, and a document 13 is set under the document cover platen 14. A reference white board 15 for shading correction is arranged at the end of the scanning plate 3.

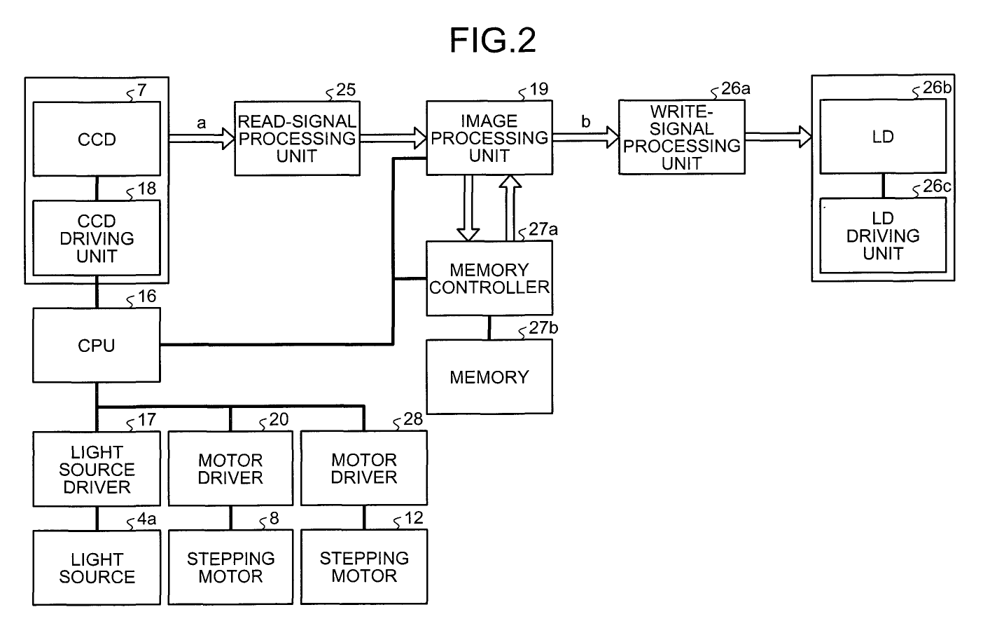

FIG. 2 is a block diagram of electrical control parts of the MFP. In FIG. 2, the image reading device includes the light source 4a, the CCD 7, the stepping motor 8 for conveying the document, a motor driver 20 for conveying the document, the stepping motor 12 for moving the moving body, a motor driver 28 for moving the moving body, a central processing unit (CPU) 16, a light source driver 17, a CCD driving unit 18, a read-signal processing unit 25, an image processing unit 19, a memory controller 27a, a memory 27b, a write-signal processing unit 26a, a laser diode (LD) 26b, and an LD driving unit 26c.

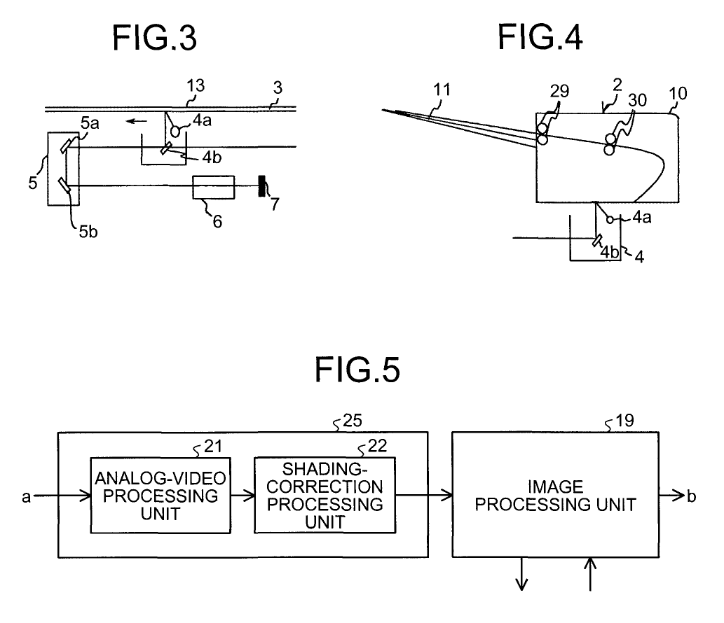

FIG. 3 is a schematic diagram of a document reading unit in a platen reading mode, and FIG. 4 is a schematic diagram of the document reading unit in a document-convey reading mode.

The document read mode includes the platen reading mode in which an image is read by using the scanning plate 3, as shown in FIG. 3, and the document-convey reading mode in which the document is moved by the document conveying unit 2, as shown in FIG. 4, with a read position being fixed.

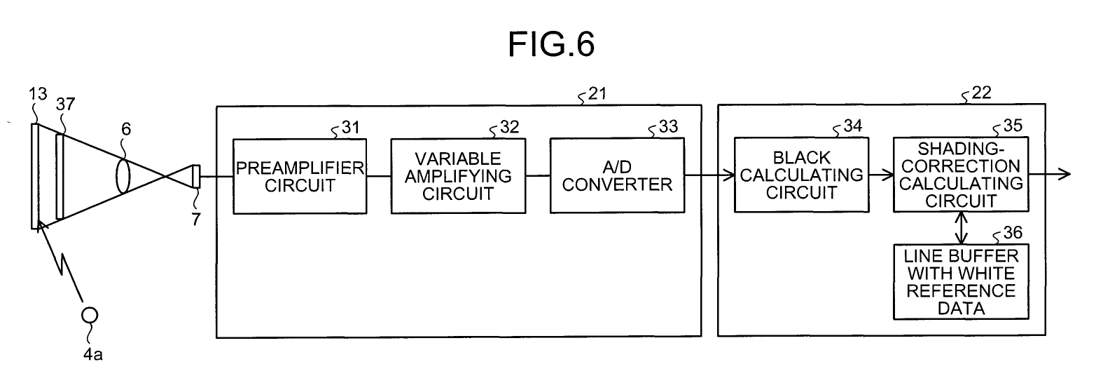

A basic operation for reading the image data in the platen reading mode is such that, as shown in FIG. 3, after the document 13 is set under the document cover platen 14 on the scanning plate 3, the CPU 16 operates the light source driver 17 to turn the light source 4a ON. The CCD 7 driven by the CCD driving unit 18 scans and reads the reference white board 15, and an analog-to-digital (A/D) conversion is performed with respect to the read data by an A/D converter (not shown) in the image processing unit 19. The read-signal processing unit 25 holds the data in a read only memory (RAM) (a line buffer 36 in FIG. 6) for a shading correction process in the image processing unit 19, as white reference data for the shading correction.

The CPU 16 operates the stepping motor 8 for moving the moving body via the motor driver 20 for moving the moving body. Accordingly, the first moving body 4 moves toward the document 13. Because the first moving body 4 scans a document surface at a constant speed, the image data of the document 13 is photoelectrically converted by the CCD 7.

FIG. 4 depicts a basic operation of the image data read in the conveying the document read mode. In the read by a sheet through (conveying the document read) method, the document is not fixed and read by scanning the carrier as in the platen reading mode, but the document is moved and read, with the first moving body 4 being made to stand still at a home position. The CPU 16 makes the first moving body 4 scan the reference white board 15 with a constant shift to read the reference white board 15 as in the platen reading mode, and then makes the first moving body 4 move to a sheet-through document read position and stand still.

The CPU 16 drives the stepping motor 12 for conveying the document via the motor driver 28 for conveying the document. The document 13 set on the document tray 11 is carried to a predetermined read position of the first moving body 4 by a separation roller 29 and a conveying roller 30. At this time, the document 13 is carried at a constant speed, and the image data on the document surface is photoelectrically converted by the CCD 7, while the first moving body 4 stands still.

FIG. 5 depicts a basic configuration of the read-signal processing unit 25 shown in FIG. 2. The read-signal processing unit 25 includes an analog-video processing unit 21 and a shading-correction processing unit 22, and transmits the data to the image processing unit 19. After the photoelectrically converted analog video signal “a” is subjected to the processing up to digital conversion by the analog-video processing unit 21, the signal “a” is transmitted to the shading-correction processing unit 22 to perform a correction process for the reader. Thereafter, the data is output to the image processing unit 19 in the subsequent stage for performing various types of image processing.

The analog-video processing unit 21 shown in FIG. 5 includes a preamplifier circuit 31, a variable amplifying circuit 32, and an A/D converter 33 as shown in FIG. 6. The shading-correction processing unit 22 includes a black calculating circuit 34 and a shading-correction calculating circuit 35, and the line buffer 36. The line buffer 36 is a memory that holds the white reference data, which becomes the reference in the shading correction.

Reflected light from the document 13 on the scanning plate 3 irradiated from the light source 4a is condensed by the lens 6 via a shading adjustment plate 37 and imaged on the CCD 7. The shading adjustment plate 37 adjusts the quantity of light for decreasing a difference in a quantity of reflected light between the center and the ends of the CCD 7. That is, if the difference in the quantity of reflected light between the center and the ends of the CCD 7 is too large, only a calculation result including a large distortion can be obtained by the shading-correction processing unit 22. Therefore, a shading-correction calculation process is performed after the difference in the quantity of reflected light is reduced. A mirror for folding the reflected light is omitted in FIG. 6.

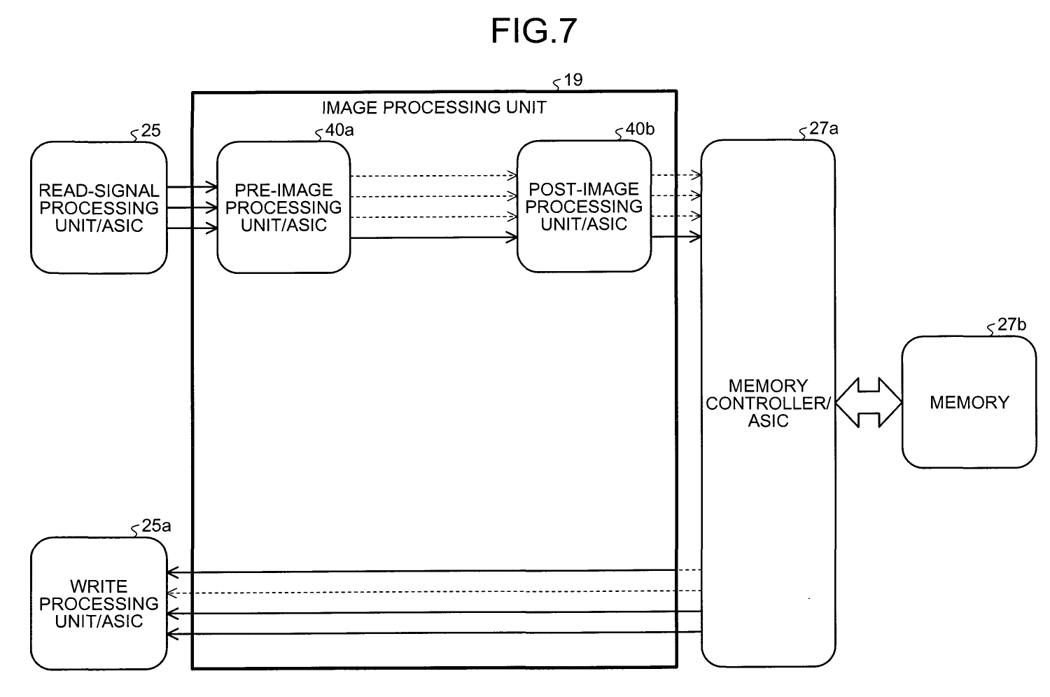

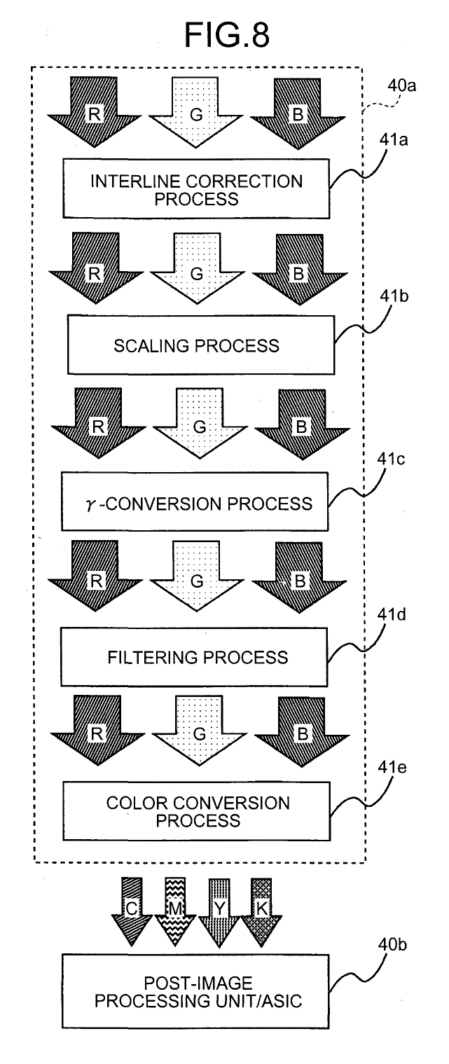

The image processing unit 19 shown in FIG. 5 includes a pre-image processing unit 40a and a post-image processing unit 40b as shown in FIG. 7. The pre-image processing unit 40a performs an interline correction process 41a, a scaling process 41b, a γ-conversion process 41c, a filtering process 41d, and a color conversion process 41e.

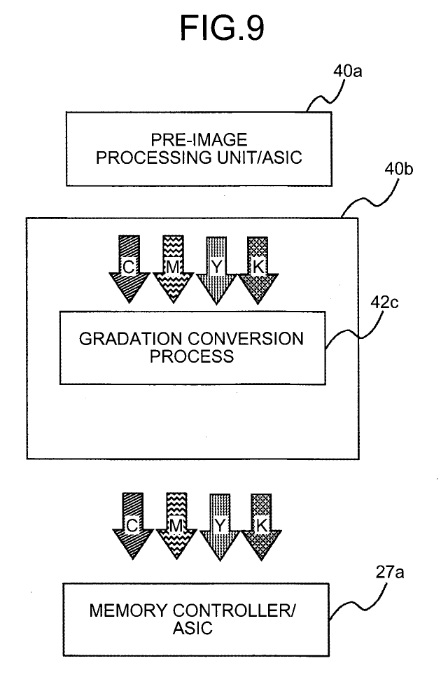

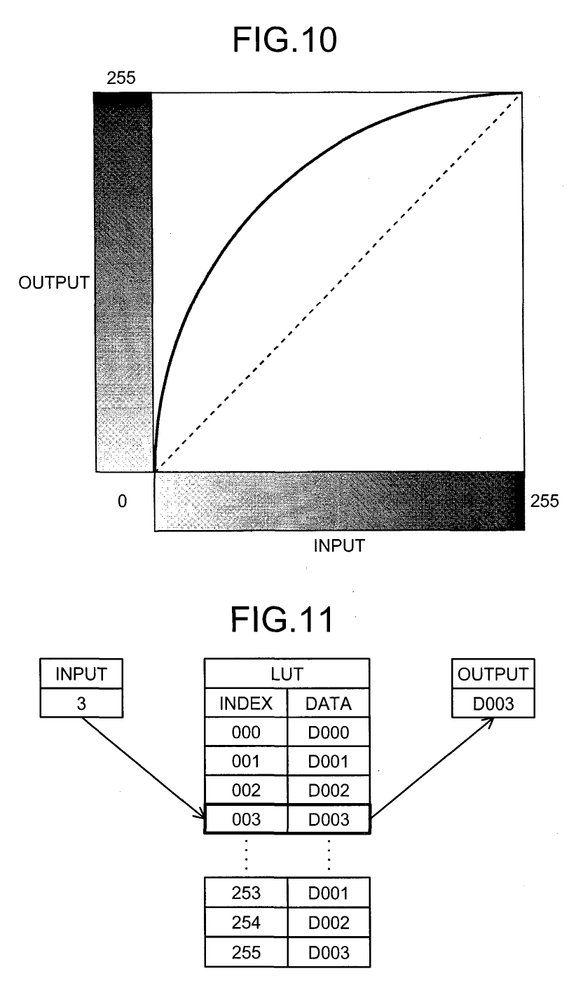

The interline correction process 41a is for correcting a line deviation between RGB, which occurs due to a difference in a fitting position of the RGB in the color CCD 7. For example, when blue (B) line is used as a reference, the interline correction process 41a corrects a line deviation amount between red (R) and B, green (G) and B. The scaling process 41b converts read resolution to desired resolution. The γ-conversion process 41c performs conversion mainly for density adjustment (for example, density adjustment shown in FIG. 10). Generally, a lookup table conversion method shown in FIG. 9 is used.

The filtering process 41d performs a filtering process for modulation transfer function (MTF) correction, sharpening, and smoothing. The color conversion process 41e performs a process for converting the RGB color to a color space of an output device, for example, cyan, magenta, yellow, black (CMYK) color space. When the image is a color image, the above processes are performed with respect to the respective components of the RGB, and when the image is a monochrome image, the above processes are performed with respect to only one component, using a G data path of the RGB. Generally, when the post-image processing unit is provided before data accumulation, gradation level is set to low, giving much weight to the minimum accumulation capacity. In the present embodiment, a binary gradation conversion process is selected.

Gradation conversion by binarizing a fixed threshold when the write unit can output up to one bit and two gradations is explained. When a binary image is desired, a gradation conversion process 42c in the post-image processing unit 40b in FIG. 9 converts the CMYK images of eight bits and 256 gradations to binary image data of two gradations, and outputs the image as image data b to the subsequent stage. As one example of fixed threshold processing for simplifying the explanation, when the threshold to be binarized is 128, a binarization is performed with respect to the pixel data of an input image under the following conditions.

When 0≦pixel data<128 is true→0

When 128≦pixel data≦255 is true→1

Gradation conversion by quaternarizing the fixed threshold when the write unit 1 can output up to two bits and four gradations is explained. When a quaternary image is desired, the gradation conversion process 42c in the post-image processing unit 40b in FIG. 9 converts the CMYK images of eight bits and 256 gradations to quaternary image data of four gradations, and outputs the image as image data b to the subsequent stage. As one example of fixed threshold processing for simplifying the explanation, a quaternarization is performed with respect to the pixel data of the input image under the following conditions.

When 0≦pixel data<64 is true→0

When 64≦pixel data<128 is true→1

When 128≦pixel data<192 is true→2

When 192≦pixel data≦255 is true→3

These image data are 1-bit or 2-bit image data for CMYK before gradation processing is performed. The image data is temporarily accumulated in the memory 27b via the memory controller 27a.

The write-signal processing unit 26a performs signal processing for emitting a laser diode used for forming the image by the write unit with respect to the data after the gradation processing. That is, the write unit generates a signal for pulse-width modulation (PWM) to form a dot, with respect to low-bit image data after the gradation processing. The LD driving unit 26c has the LD 26b emitted light according to the data to form an image on a photoconductor (not shown).

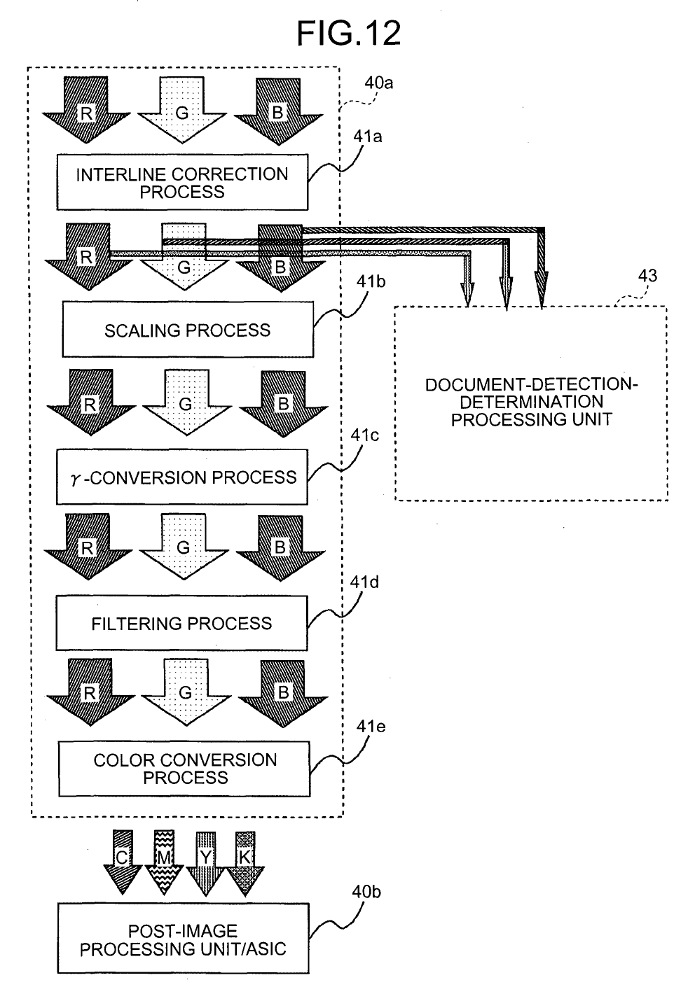

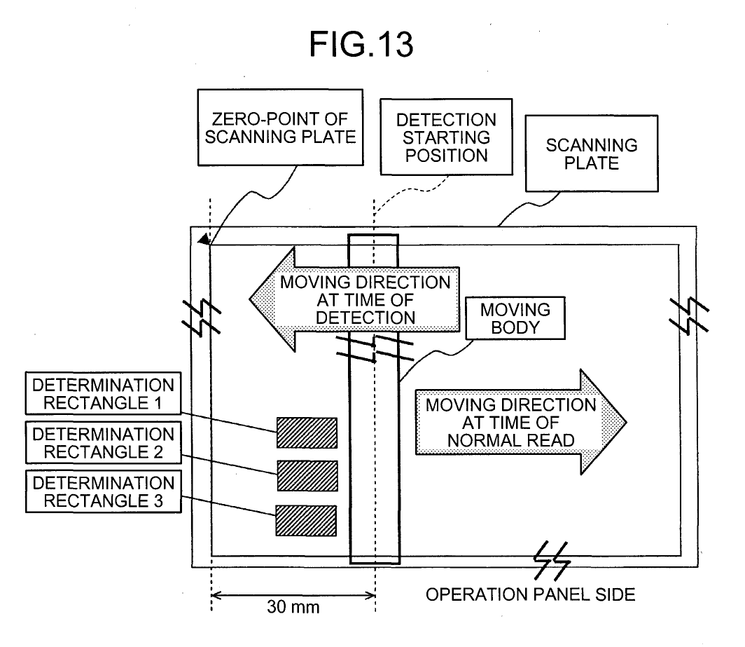

FIG. 12 depicts an operation of the present embodiment. A document detecting operation by the CCD is described first. The operation at the time of detecting a document by the CCD is performed as shown in FIG. 13. When a sensor for detecting opening or closing of the platen detects that the platen changes from opening to closing, a carrier in a scanner unit starts to move from a document detection position to a home position (leftward) (opposite to a general direction of a read operation). An area of a determination rectangle at a specified position is read until the carrier returns to the home position. That is, data of determination rectangles 1, 2, and 3 at positions shown in FIG. 13 is read.

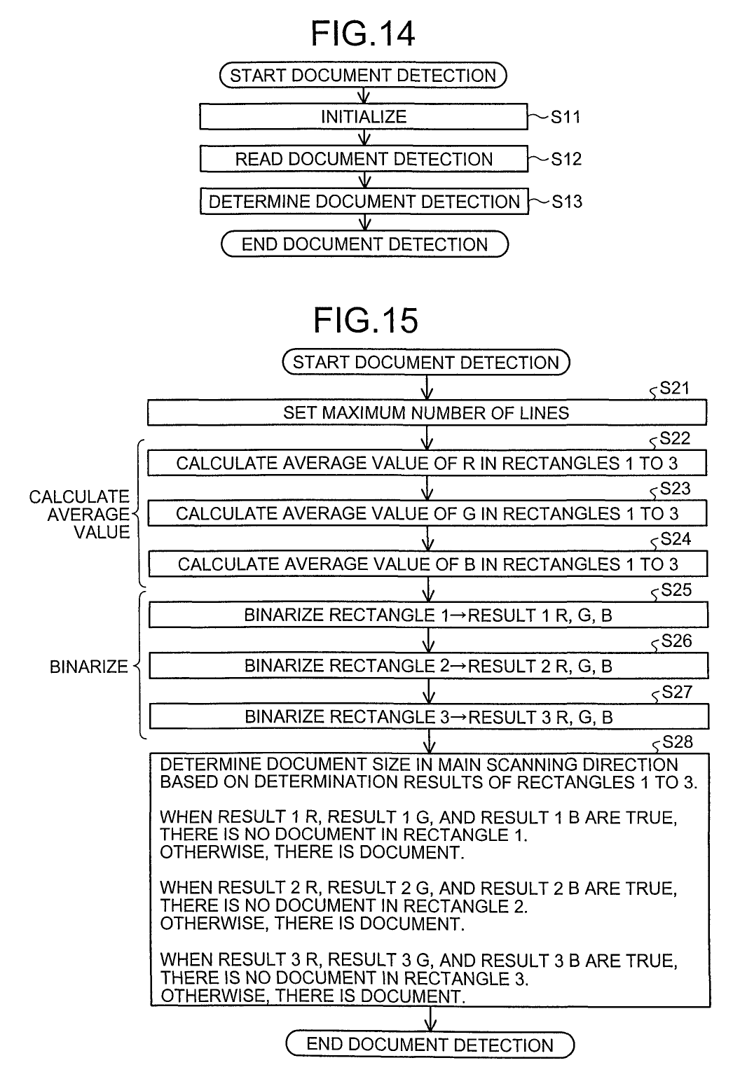

FIG. 14 is a flowchart of the entire document detection. In FIG. 14, an initial setting is performed for detection (Step S11), and then the rectangular region is read (Step S12). In the document detection at Step S12, when the entire rectangular area is stored in a memory, a document detection is performed after reading the rectangular area. On the other hand, when a line processing is performed, an average value is calculated while the rectangular area is being read, and the final document detection is performed after read of the rectangular area.

A specific flow of the image processing is explained. The read data is output to the subsequent stage after a line delay in RGB is corrected by CCD interline correction. The data of the rectangular area (patch) is held in the memory. FIG. 15 is a flowchart of determination in document detection at Step S13 in FIG. 14.

After the maximum number of lines is set at Step S21, the average value of RGB in each rectangle (patch) is calculated at Steps S22 to S24. Interpretation of the calculated data is assumed such that “0” is bright, and “255” is dark as 8-bit data. At Steps S25 to S27, the calculated average value of each rectangle area is binarized for R, G, and B. At this time, because the read image data is dark in an area where the document is not displaced, the area where the document is not displaced becomes “1” according to binarization. When the binarization results are different between R, G, and B, if a monochrome image is used for determination of document size as in the conventional art, misjudgment occurs. On the other hand, according to the present embodiment, there is no misjudgment, and accurate detection can be realized.

At Step S28, if a logical product of the binarization result of R, G, and B in each patch is true 1, all of R, G, and B are dark data, which indicates that there is no document. On the other hand, when there is at least one bright data in any of R, G, and B, the logical product becomes false 0, and it is determined that there is a document. A rectangle size in the sub-scanning direction can be determined by changing the setting of the maximum number of lines at Step S21 in FIG. 15 according to a user's instruction.

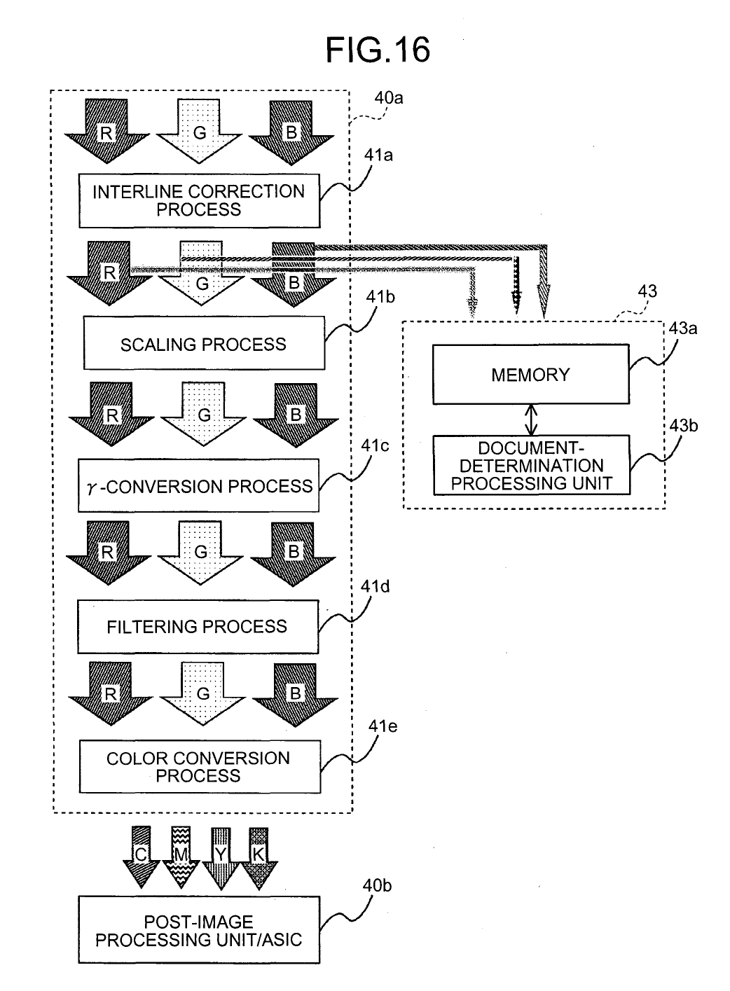

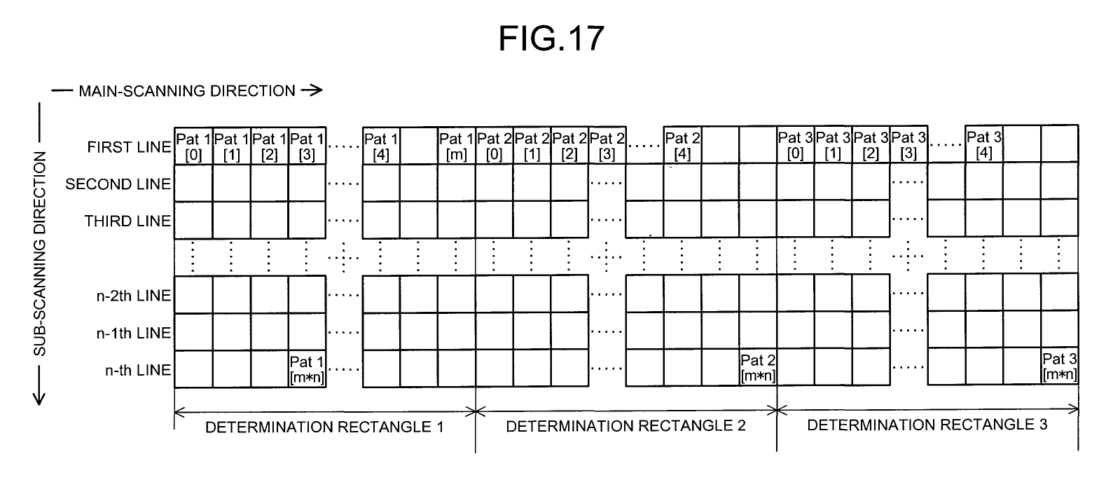

Averaging in a document detection process is explained next with reference to FIG. 16. The document detecting processor holds the entire patch area in the memory, as shown in FIG. 17. The document detecting processor adds all pixels in the patch area to calculate the average value. For example, in the case of average value Pat1Ave of patch 1, Pat1Ave→(sum total of Pat1[0]) to Pat1[m*n])÷(m*n). Other patches are calculated in the same manner.

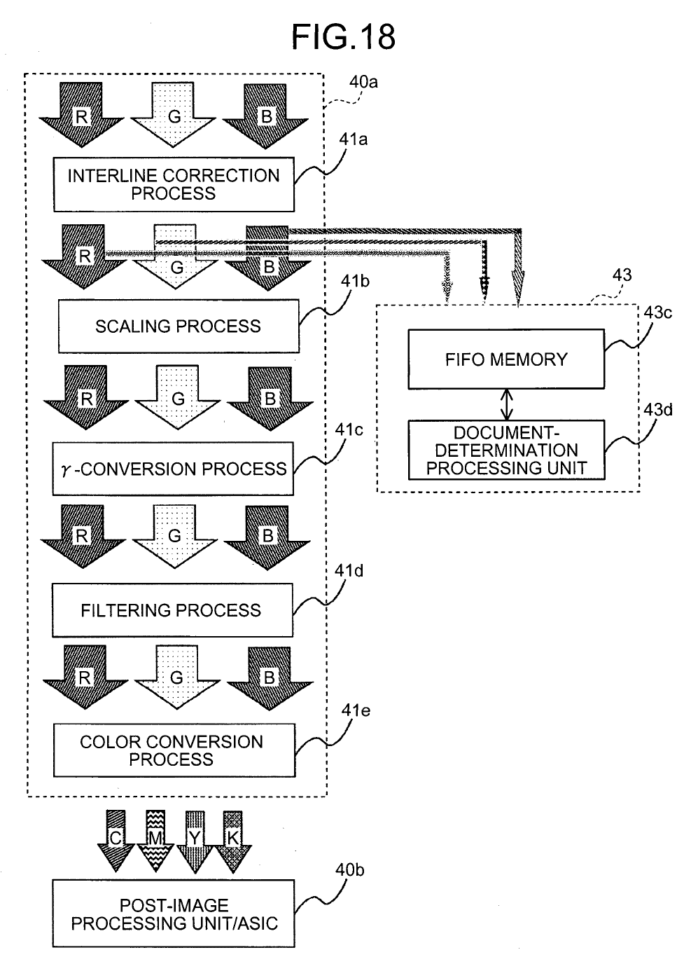

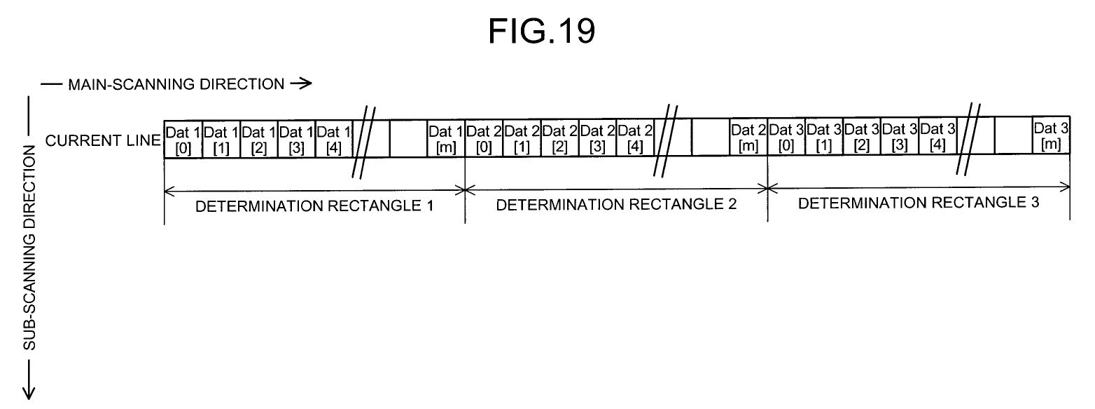

FIG. 18 is a flowchart of calculating the average value line by line. As shown in FIG. 19, a document-detection determining processor does not require the memory for the entire patch area, and includes one line data of a current line from the reading unit and average value data for holding the average value up to a previous line. For example, in the case of average value Pat1Ave of patch 1, the average value of the current line is calculated according to Expression 1.

Average of current line data: CL1Ave→(sum total of Dat1[0] to Dat1[m])÷(m+1) (Expression 1)

An average value up to the previous line Pat1Ave is calculated according to Expression 2.

Average value up to previous line: Pat1Ave→(Pat1Ave+CL1Ave)÷2 (Expression 2)

The processes of Expressions 1 and 2 are performed every time the current line is updated, and the process is executed up to the last line in the patch. In the case of the first line, the above calculation is not performed, and the CL1Ave value is held as Pat1Ave. Other patches are calculated in the same manner.

A process in which average calculation is performed for each line, and a pixel satisfying a specific condition is excluded from average calculation of a line average is explained. An average value of the current line is calculated as in the processes of Expressions 1 and 2 (first time). The average value of the current line is compared with the value of each pixel in the current line, and the average of the current line is calculated again only with the pixels matching the specific condition (second time).

The condition at this time is: when |CL1Ave−Pat1[0]|≦threshold, CL1Sum→CL1Sum+Pat[0], and pixel count K=K+1.

The process is executed with respect to all the pixels (0 to m) in one line of the current line. The average value of only the pixels satisfying the condition is calculated according to Expression 3.

The average value of the current line of only the pixels satisfying the condition is

CL1Ave→CL1Sum÷K (Expression 3)

The processes of Expressions 1 to 3 are performed every time the current line is updated, and the process is executed up to the last line in the patch. In the case of the first line, the above calculation is not performed, and the CL1Ave value is held as Pat1Ave. Other patches are calculated in the same manner.

The process in which average calculation is performed for each line, and a line average satisfying a specific condition is excluded from average calculation is explained.

The processes of Expressions 1 and 2 are performed in the same manner to calculate the average value of the current line. A difference between the average value CL1Ave of the current line and the average value Pat1Ave until the previous line is calculated. When an absolute value thereof is a specific difference or more, the average calculation of the current line and the previous line is not performed.

When |Pat1Ave−CL1Ave|>threshold, the data is held as it is, considering Pat1Ave→Pat1Ave.

When |Pat1Ave−CL1Ave|≦threshold value, the average value until the current line is calculated based on the average value until the previous line and the average value of the current line according to

Pat1Ave→(Dat0Ave+Dat1Ave)÷2 (Expression 4)

The processes of Expressions 1 to 4 are performed every time the current line is updated, and the process is executed up to the last line in the patch. In the case of the first line, the above calculation is not performed, and the CL1Ave value is held as Pat1Ave.

The process in which average calculation is performed for each line, and a pixel satisfying the specific condition is excluded from average calculation of a line average, and a line average satisfying the specific condition is excluded from the average calculation is explained.

In the document determination process, the process of Expressions 1 and 2 are performed in the same manner to calculate the average value of the current line. The average value of the current line is compared with the value of each pixel in the current line, and the average of the current line is calculated again only with the pixels matching the specific condition.

Condition: when |CL1Ave−Pat1[0]|≦threshold, CL1Sum→CL1Sum+Pat[0] (Expression 5),

and

pixel count K=K+1 (Expression 6)

The processes of Expression 5 and 6 under the above condition are executed with respect to all the pixels (0 to m) in one line of the current line. Only the average value of pixels satisfying the condition is calculated according to Expression 7.

The average value of the current line of only the pixels satisfying the condition is

CL1Ave→CL1Sum÷K (Expression 7)

A difference between the average value CL1Ave of the current line and the average value Pat1Ave until the previous line is calculated. When an absolute value thereof is a specific difference or more, the average calculation of the current line and the previous line is not performed.

When |Pat1Ave−CL1Ave|>threshold, the data is held as it is, considering Pat1Ave→Pat1Ave.

Pat1Ave→(Pat1Ave+CL1Ave)÷2 (Expression 8)

The above processes are performed every time the current line is updated, and the process is executed up to the last line in the patch. In the case of the first line, the above calculation is not performed, and the CL1Ave value is held as Pat1Ave.

The image processing program according to the present invention makes a computer execute the above processing steps. The recording medium according to the present invention is a recording medium having the image processing program computer-readably recorded therein.

As described above, according to an aspect of the present invention, the average value is calculated for each component from image data of a plurality of rectangular areas on the document, and the average value is binarized to determine the presence of the document. Therefore, even in the case of a color document, the presence of the document can be accurately determined.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a document detecting unit that detects a document from color image data of a plurality of rectangular areas at a predetermined position on a scanning plate, to determine a document size in a main-scanning direction;
an average-value calculating unit that calculates an average value of each component of the color image data in a rectangular area;
a binarizing unit that binarizes the average value calculated by the average-value calculating unit; and
a determining unit that determines a presence of the document based on a result obtained by the binarizing unit.

2. The image processing apparatus according to claim 1, wherein the average-value calculating unit calculates the average value for all pixels in the rectangle, and excludes a pixel satisfying a predetermined condition from a calculation of the average value.

3. The image processing apparatus according to claim 1, wherein the average-value calculating unit calculates the average value line by line.

4. The image processing apparatus according to claim 1, wherein the average-value calculating unit calculates the average value line by line, and excludes a pixel satisfying a predetermined condition from a calculation of a line average.

5. The image processing apparatus according to claim 1, wherein the average-value calculating unit calculates the average value line by line, and excludes a line average satisfying a predetermined condition from a calculation of the average value.

6. The image processing apparatus according to claim 1, wherein the average-value calculating unit calculates the average value line by line, and excludes a pixel satisfying a first condition from a calculation of a line average, and excludes a line average satisfying a second condition from a calculation of the average value.

7. The image processing apparatus according to claim 1, further comprising a changing unit that changes a sub-scanning size of the rectangle at time of detecting the document.

8. An image processing method comprising:
detecting a document from color image data of a plurality of rectangular areas at a predetermined position on a scanning plate, to determine a document size in a main-scanning direction;
calculating an average value of each component of the color image data in a rectangular area;
binarizing the average value calculated at the calculating; and
determining a presence of the document based on a result obtained at the binarizing.

9. The image processing method according to claim 8, wherein the calculating includes
calculating the average value for all pixels in the rectangle, and
excluding a pixel satisfying a predetermined condition from a calculation of the average value.

10. The image processing method according to claim 8, wherein the calculating includes calculating the average value line by line.

11. The image processing method according to claim 8, wherein the calculating includes
calculating the average value line by line, and
excluding a pixel satisfying a predetermined condition from a calculation of a line average.

12. The image processing method according to claim 8, wherein the calculating includes
calculating the average value line by line, and
excluding a line average satisfying a predetermined condition from a calculation of the average value.

13. The image processing method according to claim 8, wherein the calculating includes
calculating the average value line by line,
excluding a pixel satisfying a first condition from a calculation of a line average, and
excluding a line average satisfying a second condition from a calculation of the average value.

14. The image processing method according to claim 8, further comprising changing a sub-scanning size of the rectangle at time of detecting the document.

15. A computer program product comprising a computer-usable medium having computer-readable program codes embodied in the medium that when executed cause a computer to execute:
detecting a document from color image data of a plurality of rectangular areas at a predetermined position on a scanning plate, to determine a document size in a main-scanning direction;
calculating an average value of each component of the color image data in a rectangular area;
binarizing the average value calculated at the calculating; and
determining a presence of the document based on a result obtained at the binarizing.
